(19) United States
(12) Patent Application Publication
(10) Pub. No.: US 2013/0213122 A1
(43) Pub. Date: Aug. 22, 2013

(54) COMPONENT TESTING AND METHOD FOR OPERATING A MACHINE

(71) Applicants: Andreas Böttcher, Mettmann (DE); Tobias Krieger, Oberhausen (DE)

(72) Inventors: Andreas Böttcher, Mettmann (DE); Tobias Krieger, Oberhausen (DE)

(21) Appl. No.: 13/882,802

(22) PCT Filed: Nov. 2, 2010
(86) PCT No.: PCT/EP11/68211

§ 371 Date: May 1, 2013

(30) Foreign Application Priority Data
Nov. 2, 2010 (EP) 10189669.4

(51) Int. Cl. G01M 15/14

(52) U.S. Cl. CPC G01M 15/14
USPC 73/112.01

(57) ABSTRACT

A method for testing a component for determining a maximum period of use for renewed use of the component is proposed. The component was in use and is subjected to a refurbishment for reuse. Core drilling of the used component enables a simultaneous refurbishment of the component. The state of the component is analyzed.

### CROSS REFERENCE TO RELATED APPLICATIONS

This application is the US National Stage of International Application No. PCT/EP2011/068511 filed Oct. 19, 2011 and claims benefit thereof, the entire content of which is hereby incorporated herein by reference. The International Application claims priority to the European application No. 10189669.4 filed Nov. 2, 2010, the entire contents of which is hereby incorporated herein by reference.

### FIELD OF INVENTION

The invention relates to the testing of a component after use in a machine and to a method for operating a machine having refurbished components.

### BACKGROUND OF THE INVENTION

Components of a gas turbine are designed for a specific service life and examined for damage at various inspection intervals. In this respect, it is an aim to estimate the remaining service life of a component until failure as accurately as possible in order to replace or to repair the component concerned as optimally and as accurately as possible just before the failure limit. Such a prediction reduces the costs for an unnecessary exchange of affected components which are still a long way off their failure limit.

To date, components have been examined visually for cracks or similar signs of operating fatigue at various inspection intervals. This examination is very inaccurate and permits no statement to be made about the state of the component on the inside. Furthermore, components are destroyed in order to gain information about their operational loading and mechanical properties on the inside. This has the effect that, although components can be investigated extensively, they are not reused after the examination. Similarly, it is possible that components are refurbished (rejuvenation) and reused.

### SUMMARY OF INVENTION

It is an object of the invention therefore to solve the aforementioned problem.

The object is achieved by a method as claimed in the independent claims.

The dependent claims list further advantageous measures which can be combined with one another, as desired, in order to achieve further advantages.

It is proposed to take samples of the component using one or more targeted core drilling operations and to derive the operational loading on the basis of these samples. All known examination methods can be carried out with this core, and therefore a considerably more accurate statement about the remaining service life of the component can be made with the aid of these results. As a consequence, components can be managed closer to the actual loading limit and unjustified replacements of components are avoided. The sample geometry taken from the component can preferably be closed again with a pin, and therefore the examined component can be reused for operation.

### BRIEF DESCRIPTION OF DRAWINGS

In the drawings:

FIGS. 1-4 schematically show steps of the method according to the invention,

FIG. 5 shows a turbine blade or vane,

FIG. 6 shows a combustion chamber,

FIG. 7 shows a gas turbine, and

FIG. 8 shows a list of superalloys.

### DETAILED DESCRIPTION OF INVENTION

The figures and the description represent only exemplary embodiments of the invention.

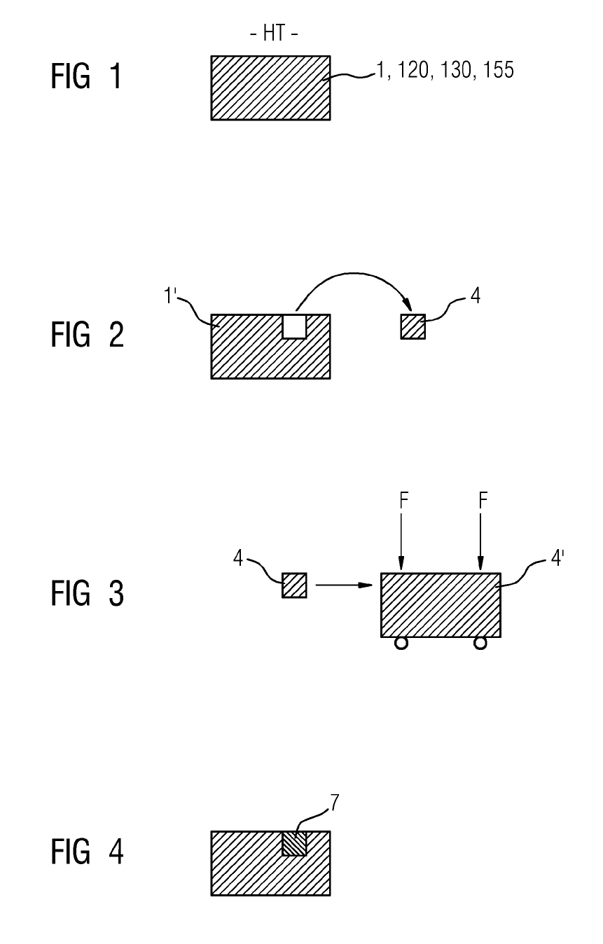

FIG. 1 shows a component 1 which was exposed to high temperatures (HT).

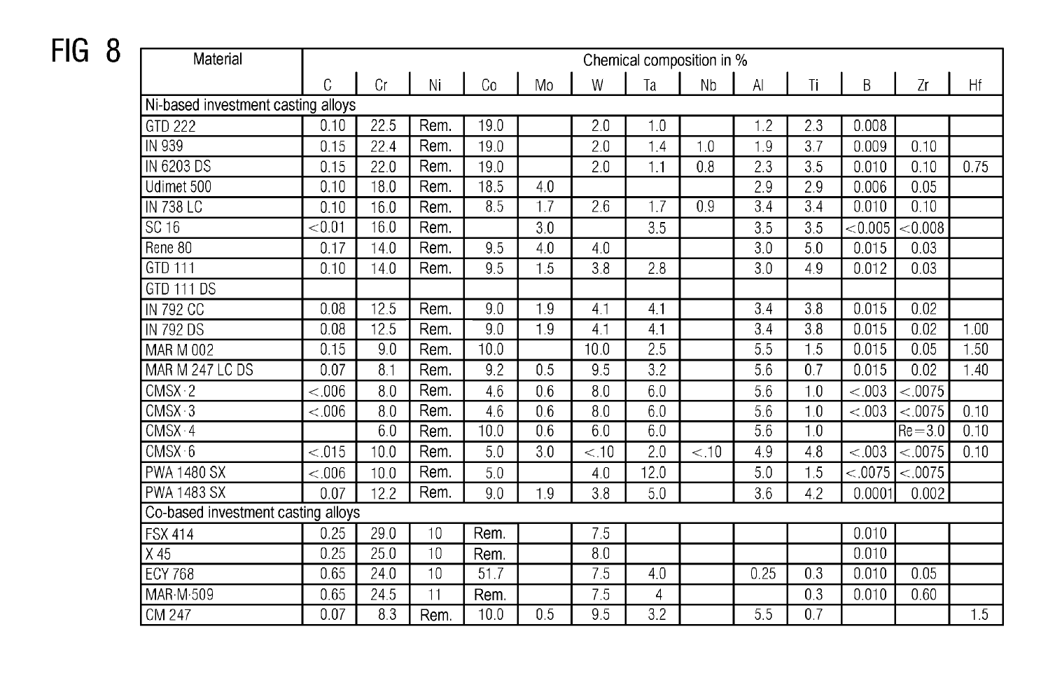

The component 1 is preferably a turbine blade or vane 120, 130 which was in use and preferably consists of a superalloy, as shown in FIG. 8, or comprises such a superalloy. Such components 120, 130, 155 which were in use at high temperatures have layers which are then removed for reuse. Optionally, rejuvenation measures (for example solution annealing and reprecipitation of hardened areas which can be precipitated) are also carried out with the component 1, 120, 130, 155.

FIG. 2 shows that at least one core 4, in particular only one core 4, is removed from the component 120, 130 at at least one site.

The core 4 can be removed from the component 1, 120, 130 before or after the measures for rejuvenating the latter.

Similarly, a plurality of cores 4 can be removed, in particular at various sites. An examinable core 4 is therefore present. The core 4 can have any desired shape. The core 4 can also be divided up further for the examinations (chemically, mechanically, visually) and/or be used in succession.

It is similarly preferable that the core 4′ undergoes the same rejuvenation heat treatments as the component 1′ and is then examined mechanically and/or microscopically. It is preferable for only mechanical tests to be carried out.

As shown schematically in FIG. 3 as a sample 4′, this core 4 can be examined to determine mechanical strength values under the action of a force F (LCF, HCF, strength in general).

The component 1, 120, 130, 155 or the substrate from which a core 4 has been removed is refilled with a filler material 7. The filler material 7 can preferably be solder material, welding material, a soldered-in or welded-in pin.

The method has the advantage that the component 1, 120, 130, 155 can be installed and used again and statements about the actually possible loading limit or period of time can be made later, such that there is no time delay for the reinstallation of used components (120, 130) if the examinations are time-consuming, such as “low cycle fatigue”.

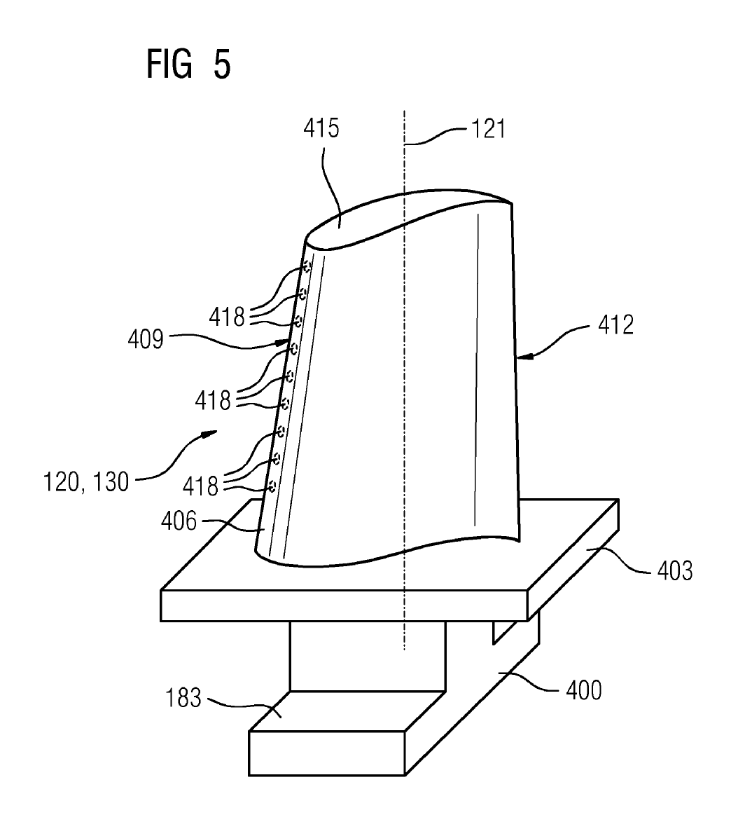

FIG. 5 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415. As a guide vane 130, the vane 130 may have a further platform (not shown) at its vane tip 415.

A blade or vane root 183, which is used to secure the rotor blades 120, 130 to a shaft or a disk (not shown), is formed in the securing region 400. The blade or vane root 183 is designed, for example, in hammerhead form. Other configurations, such as a fir-tree or dovetail root, are possible. The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130. Superalloys of this type are known, for example, from EP 1 204 776 B1, EP 1 306 454, EP 1 319 729 A1, WO 99/67435 or WO 00/44949. The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures). Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1. The density is preferably 95% of the theoretical density. A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX. The thermal barrier coating covers the entire MCrAlX layer.

Columnar grains are produced in the thermal barrier coating by suitable coating processes, such as for example electron beam physical vapor deposition (EB-PVD). Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

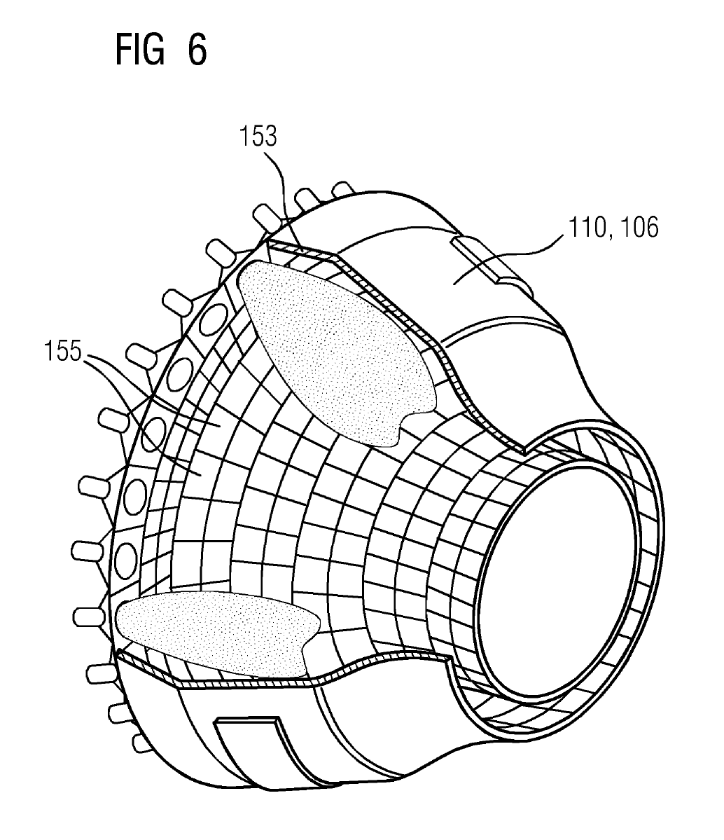

FIG. 6 shows a combustion chamber 110 of a gas turbine. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide. Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from heat shield elements 155 (e.g. by sand-blasting). Then, the corrosion and/or oxidation layers and products are removed. If appropriate, cracks in the heat shield element 155 are also repaired. This is followed by recoating of the heat shield elements 155, after which the heat shield elements 155 can be reused.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

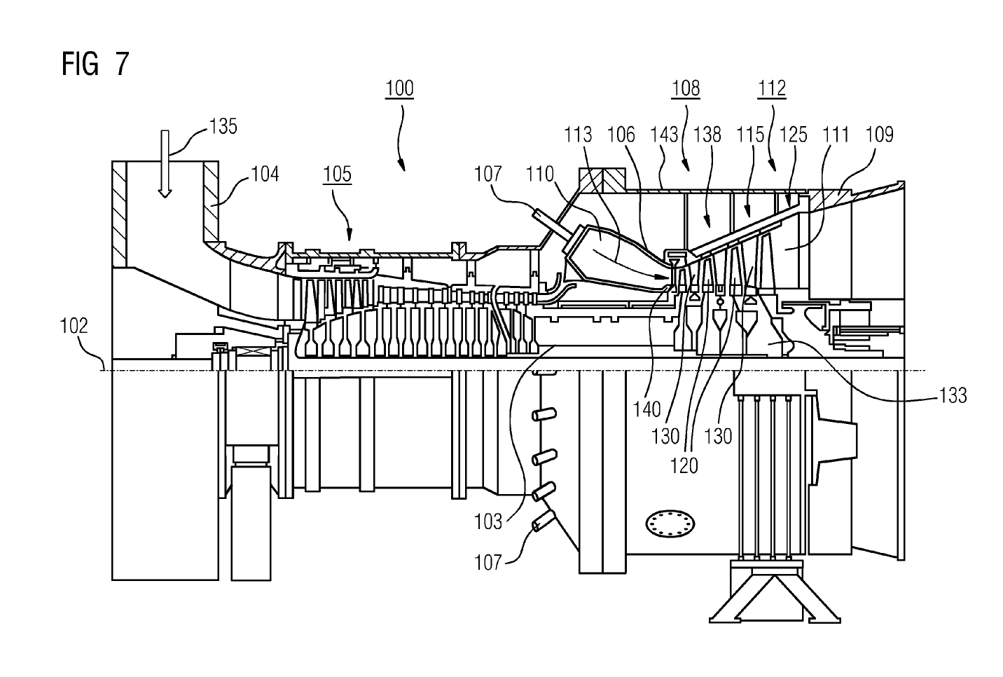

FIG. 7 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor. An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103. The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses. To be able to withstand the temperatures which prevail there, they may be cooled by means of a coolant. Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110. Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B1, EP 0 786 017 B1, EP 0 412 397 B1 or EP 1 306 454 A1.

It is also possible for a thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide. Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

1.-15. (canceled)

16. A method for testing a component for determining a maximum period of use for renewed use of the component, wherein the component was in use and is subjected to a refurbishment for reuse, comprising:
removing a core from the used component at a site before reuse; and
examining the core to determine a period of use and/or loading data of the component for the renewed use of the component,
wherein a same heat treatment is carried out with the core as with the component.

17. The method as claimed in claim 16, wherein a mechanical examination is carried out with the core.

18. The method as claimed in claim 16, wherein a chemical examination is carried out with the core.

19. The method as claimed in claim 16, wherein a metallographic examination is carried out with the core.

20. The method as claimed in claim 16, wherein the site from which the core has been removed is filled again by soldering or welding or by a pin.

21. The method as claimed in claim 16, wherein the core has a solid form or is elongate.

22. The method as claimed in claim 16, wherein the core is removed at various sites of the component.

23. The method as claimed in claim 16, wherein only one core is removed.

24. The method as claimed in claim 16, wherein the core is split into a plurality of parts for the examination.

25. The method as claimed in claim 16, wherein the core is removed before the refurbishment.

26. The method as claimed in claim 16, wherein the core is removed after the refurbishment.

27. The method as claimed in claim 16, wherein the refurbishment comprises a layer removal.

28. The method as claimed in claim 16, wherein the heat treatment comprises solution annealing and a precipitation heat treatment.

29. A method for operating a machine having a component, comprising:
removing a core from the component as claimed in claim 16;
refurbishing the component; and
reusing the refurbished component in the machine; and
examining the core after the renewed and a first use of the refurbished component.

30. A method for operating a machine having a component, comprising:
removing a core from the component as claimed in claim 16;
refurbishing the component; and
reusing the refurbished component in the machine; and
examining the core before the renewed and a first use of the refurbished component.
